(19) United States
(12) Patent Application Publication
(10) Pub. No.: US 2007/0157496 A1
(43) Pub. Date: Jul. 12, 2007

(54) Construction signage system

(76) Inventor: Wendy Scribner, Boise, ID (US)

Correspondence Address: ROBERT L. SHAVER;DYKAS, SHAVER & NIPPER, PO BOX 877, BOISE, ID, 83701-0877, US

(21) Appl. No.: 11/328,817

(22) Filed: Jan. 9, 2006

(51) Int. Cl. G09F 15/00

(52) U.S. Cl. 40/607.05

(57) ABSTRACT

A signage system for use on construction sites that includes a pair of stakes, which are inserted into vertical channels into a signboard, and when inserted into the ground support the sign board, which is preprinted with categories of identifying criteria and entry positions for manual entry of information specific to a construction site and with a document storage container for attachment to the signage system. The signboard of the signage system is reusable, erasable and waterproof.

### FIELD OF THE INVENTION

The present invention generally relates to signage systems, and more particularly relates to signage systems for construction sites.

### BACKGROUND OF THE INVENTION

When a new home is being built, there is a large period of time in which the house is totally unidentified as to address, and therefore is very difficult to find. This problem can be complicated when there are a number of houses being built at the same time in the same general area or street, such as in a subdivision. With no address posted, it is a huge problem for subcontractors and other people to find the correct building site. It is not uncommon for subcontractors to show up at a construction site that they think is the correct one, perform work, such as pouring a driveway, install plumbing fixtures, etc., and later find out that the work was performed on the wrong site. It is also a problem for inspectors who need to find the site and inspect a certain part of the construction. The contractor pays for the inspector to appear at the site, and if the inspector goes to the general area but cannot find the correct house, the contractor still has to pay the inspector's fee. It can also be difficult for buyers to be sure that they are looking at the correct home or lot if there is no identification. Subcontractors who can be confused, inconvenienced, or mistakenly perform work on such a poorly identified location include floorers, painters, carpet layers, concrete pourers, installation installers, electricians, plumbers, roofers, excavators, etc.

Any sign that is placed on such a site needs to contain certain information that is needed by different parties, must be waterproof, preferably reusable and easily visible. At present, the need for signage on a construction site, such as a residential home, is typically solved by using a piece of scrap lumber, such as piece of plywood. The piece of plywood is then either nailed to a wall, or placed on a stake driven into the ground. Oftentimes the stake is a piece of scrap two by four inch lumber found on the construction site. This method has the disadvantage that such a sign typically is not professionally prepared and can make the builder's work look sloppy. Also, it is difficult to write on plywood or other composite woods and a builder may not have a marker that has a good appearance on such a material.

Additionally, homemade signs such as signs made on plywood are not made to operate with a container for holding permits, which is increasingly used on construction sites. Therefore, what is needed is an attractive signage system that has preprinted categories of information, and blank areas for the specific information about a site to be entered. The sign should be visible from the street and presents a professional appearance, be reusable and waterproof. It should be part of a signage system, that includes stakes and which interacts with waterproof permit containers. The system should be configured so that it can be disassembled and packaged into a compact box or envelope for shipping.

### SUMMARY OF THE INVENTION

These and other objects are accomplished by the construction signage system of the present invention. The present invention is a construction site signage system that includes a reusable plastic signboard. The signboard has a front face and a rear face. The two faces are separated by a plurality of vertical chambers. The signage system includes a pair of stakes, with each stake being a metal rod. Each of the metal rods of the stakes has a signboard positioning detent. Each stake is approximately as long as the plastic signboard, and each stake has a first end and a second end. This length of sign facilitates placing the stakes on top of the signboard, and having them fit neatly into a compact box or envelope for shipping. The stakes can also be configured to be approximately as long as the diagonal as the signboard. In this way, they would still fit within an envelope for mailing without having excessive over length of stakes.

The front face of the signboard is preprinted with categories of identifying criteria. These criteria could be such things as the name of builder, the address of the site, the lot and block number and the parcel number. Other category names are also possible. Associated with each category would be a space appropriate for a person to manually enter information. The front face of the sign board is configured to be erasable so that a felt tip ink pen may be used to write the information, which may be erased by rubbing at a later time and replaced with other pertinent information. In this way, the site signage system is reusable from one construction project to another.

The stakes are configured to have the first end of the stake inserted into one of the vertical channels of the signboard, as far as the positioning detent allows. The second end of the stake is available to be inserted into the soil at the construction site. The two stakes that are available for each sign make a stable, solid, reusable, and removable positioning system for the signboard.

The positioning detents on the stakes can take a number of forms. One form is a simple U or V shaped bend in the metal rod of the stake. This U or V shaped bend is configured to not fit into the vertical channels and thus will not allow the stake to be inserted too deeply into the sign and will also not allow the sign to slide down the stakes. Other types of detents are also possible, such as an enlarged region of the stake, an attachment such as a nut and bolt, or other detent forms that prevent the sign from sliding down the stakes.

The signboard of the signage system may also have a mounting means for mounting one or more document storage containers thereto. Such document storage containers are typically used for housing waterproof environment papers such as permits. The mounting means on the signboard can be merely strategically placed holes in the signboard through which a tying means can be used to attach the document storage container. The tying means can be plastic tie strips or other conventional connection means. Other mounting means are also possible, such as hooks or protruding pegs, on which a document storage container can be hung.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention, which is measured by the claims, nor is it intended to be limiting as to the scope of the invention in any way.

Still other features and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the signage system.

FIG. 2 is a perspective view of a back side of the signboard with a document container attached.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

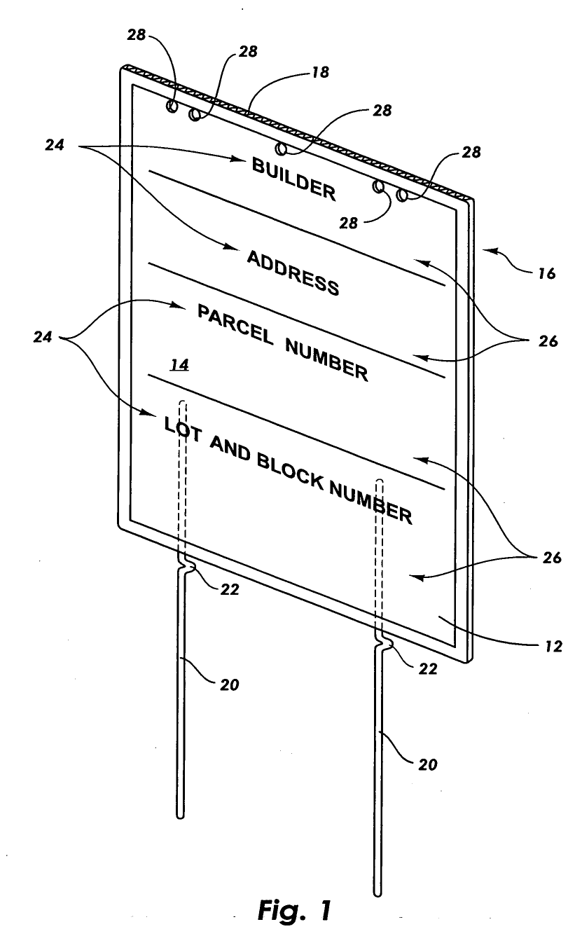

FIG. 1 shows a preferred embodiment of the present invention. FIG. 1 is a perspective view of the construction site signage system of the present invention, and includes a signboard 12, which has a front face 14, a rear face 16, and a number of vertical channels 18. A material that has proven to be effective is Coreplast, which is made of plastic and has vertical channels between a front and rear face. The channels are formed by corrugations in the inner material.

Shown is a pair of stakes 20, each with a positioning detent 22. The front face 14 includes categories 24 of identifying criteria with entry positions 26 available for writing in specific information about a particular construction site. Although shown in an assembled form, the site signage system is intended to be disassembled for shipping in a box or envelope and assembled on a construction site. The system can also be dissembled between uses, when it might be placed in storage.

The stakes 20 are designed to be inserted so that the first end of the stake 20 is in one of the vertical channels 18 of the plastic signboard. The front face of the signboard is configured for erasable display of site specific information.

Included on the plastic signboard are mounting brackets 28 in the form of openings that are defined in the signboard 12. These openings are configured to allow the attachment of document storage containers. Such an attachment can be made using a conventional attachment system, with plastic ties being one example. Other mounting brackets 28 are also possible, such as hooks or pegs. Such hooks or pegs would preferably extend from the rear face 16, and be configured to interact with documents storage containers. Such document storage containers are available to store permits or other documents that are associated with the construction site.

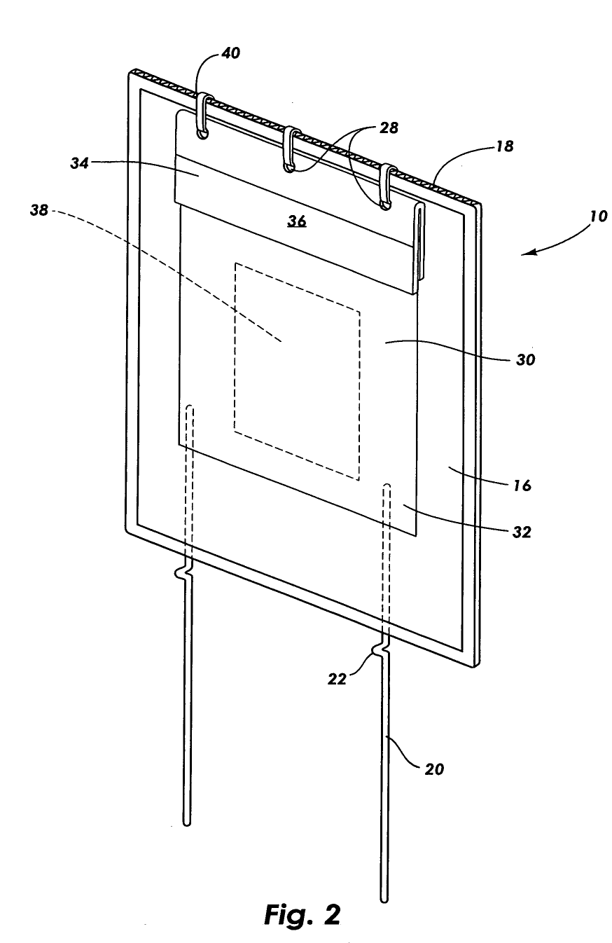

FIG. 2 is a perspective view that shows the rear face 16 of the construction signage system 10. Attached to the rear face 16 is a document storage container 30. The preferred document storage container 30 includes a flexible bag portion 32 and a self-closing lid 34. The lid 34 has a flap attached to the rest of the lid 34. The flap 36 opens to allow access to the bag portion 32 so that documents 38 can be inserted into the document storage container 30. These documents would typically be building permits, construction site inspection forms, documents required by contractors on a construction site, and other papers related to a construction site. Preferably the bag portion 32 is made of a material which protects the documents 38 from solar radiation. This could be illuminized plastic material of a number of different compositions such as polyethylene, polypropylene, mylar and other materials. The plastic material could also be made opaque, or be coated with a material which filters ultra violet radiation from sunlight and thus, protects the documents inside. The signage system of the invention also includes attachment means 40 for attaching the document storage container to the signboard. The type of attachment means shown in FIG. 2 are plastic straps but other attachment means are also possible such as hooks, hook and loop fabric, adhesives, snaps, pins, bolts and other conventional attachment structures. The preferred embodiment includes 5 mounting brackets, so that document containers of different sizes can be utilized.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A construction site signage system, comprising:
a plastic signboard, comprised of a front face, a rear face, with said faces separated by a plurality of vertical channels;
a pair of stakes, each stake comprising a metal rod with a signboard positioning detent, and having a first end and a second end;
said front face preprinted with categories of identifying criteria, with entry positions for entry of site specific information for each category; wherein
said stakes are configured to have said first end inserted into said vertical channels of said plastic signboard as far as the positioning detent allows, and to have said second end of stakes inserted into soil at a construction site, thus providing a positioning system for said signboard, with said signboard front face available for display of site specific information.

2. The construction site signage system of claim 1 in which said plastic signboard is configured to be erasable and reusable, and is provides an erasable display of information.

3. The construction site signage system of claim 1 in which each stake is approximately as long as said plastic signboard.

4. The construction site signage system of claim 1 in which said plastic signboard faces include a mounting bracket for use in attaching a document storage container to said plastic signboard.

5. The construction site signage system of claim 1 which further includes a document storage container for attachment to said plastic signboard.

6. The construction site signage system of claim 4 in which said mounting bracket comprises one or more holes defined in said signboard.

7. The construction site signage system of claim 6 in which said mounting bracket comprises three holes defined in said front face, for attachment of a document storage container to said signboard.

8. The construction site signage system of claim 6 in which said mounting bracket comprises five holes defined in said signboard, positioned to allow attachment of more than one size of document storage containers.

9. The construction site signage system of claim 1 in which said detent in said stakes is a convolution of a metal rod of said stake.

10. A construction site signage system, comprising:
a reusable plastic signboard, comprised of a front face, a rear face, with said faces separated by a plurality of vertical channels;
a pair of stakes, each stake comprising a metal rod with a signboard positioning detent formed by a convolution in the stake body, with each stake being approximately as long as said plastic signboard, and having a first end and a second end;
said front face preprinted with categories of identifying criteria, with entry positions for entry of site specific information in each category, and said front face configured for erasability and reuse;
a document storage container for attachment to said signboard; and
a mounting bracket for use in attaching said document storage container to said plastic signboard, in the form of one or more holes defined in said signboard; wherein
said stakes are configured to have said first end inserted into said vertical channels of said plastic signboard as far as the positioning detent allows, and to have said second end of stakes inserted into soil at a construction site, thus providing a positioning system for said signboard, with said signboard front face available for erasable of site specific information.

11. The signage system of claim 10 in which said document storage container further comprises a self closing waterproof closure, and a flexible bag attached to the closure.

12. The signage system of claim 11 in which the flexible bag further comprises a bag body made of aluminized material for protection of documents from solar radiation.
